(19) United States
(12) Patent Application Publication
(10) Pub. No.: US 2024/0064067 A1
(43) Pub. Date: Feb. 22, 2024

(54) POSITION CONTROL APPARATUS, METHOD, AND PROGRAM

(71) Applicant: NIPPON TELEGRAPH AND TELEPHONE CORPORATION, Tokyo (JP)

(72) Inventors: Haruhisa NOZUE, Musashino-shi, Tokyo (JP); Kazuaki AKASHI, Musashino-shi, Tokyo (JP)

(73) Assignee: NIPPON TELEGRAPH AND TELEPHONE CORPORATION, Tokyo (JP)

(21) Appl. No.: 18/269,568

(22) PCT Filed: Jan. 4, 2021
(86) PCT No.: PCT/JP2021/000033

§ 371 Date: Jun. 26, 2023

(51) Int. Cl. H04L 41/22; H04L 41/122; H04L 12/42

(52) U.S. Cl. CPC H04L 41/22; H04L 41/122; H04L 12/42

(57) ABSTRACT

A position control device according to an embodiment includes: a setting unit that inputs information on a plurality of nodes displayable on a screen and at least one edge connecting two of the multiple nodes, and sets a virtual node which generates an attractive force or a repulsive force for a node having a predetermined feature out of the plurality of nodes indicated by the information thus input; a calculation unit that calculates an attractive force or a repulsive force related to the plurality of nodes and the virtual node set by the setting unit; and a control unit that controls display positions of the plurality of nodes on the screen on the basis of the attractive force or the repulsive force calculated by the calculation unit.

### TECHNICAL FIELD

An embodiment of the present invention relates to a position control device, method, and program.

### BACKGROUND ART

In order for a communication network (network) to be efficiently maintained and operated, the configuration of a target network (network topology), here, the connection relationship of nodes constituting the network is required to be displayed on a screen so as to be easily viewable by a network maintenance administrator (hereinafter, maintenance person) according to a purpose. In particular, in a complicated network or a network having a large number of nodes, it is a problem to specify how to arrange the nodes on the screen.

For the automatic arrangement of the nodes so that the configuration of the network is appropriately displayed on the screen, there are various methods, for example, methods shown in the following (1) and (2).

(1) Node Arrangement by Dynamic Model (Known First Technique)

The force-directed method, which is an algorithm based on a dynamic model, is well known as an algorithm that realizes an arrangement easily viewable by a maintenance person on the basis of a network topology (for example, see Non Patent Literature 1).

This dynamic model is a model used to calculate an arrangement of nodes in which a repulsive force is applied between nodes (for example, like a Coulomb repulsive force acting between molecules,), an attractive force acting like, for example, a spring is applied to an edge between connected nodes, and the sum of the attractive force and the repulsive force is used to minimize energy. When the attractive force and the repulsive force between the nodes are balanced, it brings about an arrangement result in which the nodes are easily viewable with a moderate sense of distance.

By appropriately applying the dynamic model, nodes and edges do not overlap with each other with a moderate sense of distance, and nodes having a connection relationship with each other are arranged close to each other, so that an easily viewable arrangement can be obtained.

However, here, since the arrangement of nodes is determined only on the basis of the information on the connection relationship between the nodes, an arrangement taking into consideration of information other than the connection relationship cannot be obtained.

(2) Node Arrangement in Hierarchical Network (Known Second Technique)

Although techniques for realizing a node arrangement based on a network hierarchy have been proposed and implemented, in many of these techniques, a directed acyclic graph (DAG) is assumed, or an arrangement in which nodes of the same layer are simply arranged in a line in a horizontal direction of a screen, for example, is executed.

### CITATION LIST

### Non Patent Literature

Non Patent Literature 1: Fruchterman, T. M. J., Reingold, E. M.: Graph Drawing by Force-directed Placement, Software—Practice and Experience, 11, 21, 1129-1174 (1991).
Non Patent Literature 2: wikipedia “Layered_graph_drawing”, https://en.wikipedia.org/wiki/Layered_graph_drawing

### SUMMARY OF INVENTION

### Technical Problem

There is a network being divided into several layers and having redundancy by a ring-shaped configuration.

There are the following demands (1) to (3) in displaying such a network configuration. However, it is difficult to obtain an arrangement that is easily viewable by a maintenance person with only the known first and second techniques.
(1) A demand that, in consideration of the network hierarchy, for example, the nodes of the upper layer be arranged to be displayed at an upper part of the screen and the nodes of the lower layer be arranged to be displayed at a lower part of the screen
(2) A demand that the ring-shaped device group be displayed in a ring shape on the screen
(3) A demand that, on the basis of the above (1) and (2), nodes and edges be arranged to be easily viewable without overlapping as much as possible like a dynamic model

The present invention has been made in view of the above circumstances, and an object thereof is to provide a position control device, method, and program capable of appropriately arranging nodes in consideration of the characteristics of the nodes.

### Solution to Problem

A position control device according to an aspect of the present invention includes: a setting unit that inputs information on a plurality of nodes displayable on a screen and at least one edge connecting two of the multiple nodes, and sets a virtual node which generates an attractive force or a repulsive force for a node having a predetermined feature out of the plurality of nodes indicated by the information thus input; a calculation unit that calculates an attractive force or a repulsive force related to the plurality of nodes and the virtual node set by the setting unit; and a control unit that controls display positions of the plurality of nodes on the screen on the basis of the attractive force or the repulsive force calculated by the calculation unit. The term “virtual” in the “virtual node” is used to mean that the virtual node is not directly displayed on the screen but affects the arrangement of nodes.

A position control method according to an aspect of the present invention is a method performed by a position control device, and includes: inputting information on a plurality of nodes displayable on a screen and at least one edge connecting two of the plurality of nodes, and setting a virtual node which generates an attractive force or a repulsive force for a node having a predetermined feature out of the plurality of nodes indicated by the information thus input; calculating an attractive force or a repulsive force related to the plurality of nodes and the virtual node thus set; and controlling display positions of the plurality of nodes on the screen on the basis of the attractive force or the repulsive force thus calculated.

### Advantageous Effects of Invention

According to the present invention, it is possible to appropriately arrange nodes in consideration of the characteristics of the nodes.

### BRIEF DESCRIPTION OF DRAWINGS

FIG. 1 is a block diagram illustrating an application example of a network configuration diagram generation device according to an embodiment of the present invention.

FIG. 2 is a flowchart illustrating an example of a processing operation by the network configuration diagram generation device according to the embodiment of the present invention.

FIG. 3 is a diagram illustrating an example of a nodes arrangement result according to a general dynamic model.

FIG. 4 is a diagram illustrating an example of a nodes arrangement result by the network configuration diagram generation device according to the embodiment of the present invention.

FIG. 5 is a block diagram illustrating an example of a hardware configuration of the network configuration diagram generation device according to the embodiment of the present invention.

### DESCRIPTION OF EMBODIMENTS

An embodiment according to the present invention will be described below with reference to the drawings.

A network configuration diagram generation device (position control device) according to the embodiment of the present invention arranges a virtual node that causes an attractive force or a repulsive force to act only on a node having a specific feature, and controls a position of the node having the specific feature. Examples of the shape of the virtual node include a dotted shape and a linear shape.

For example, assuming that the network has three layers, the network configuration diagram generation device arranges a horizontal line-shaped virtual node, which applies an attractive force only to a device in the upper layer, at an upper part of the screen, arranges a horizontal line-shaped virtual node, which applies an attractive force only to a device in the middle layer, near the center of the screen, and arranges a horizontal line-shaped virtual node, which applies an attractive force only to a device in the lower layer, at a lower part of the screen.

The network configuration diagram generation device arranges nodes in each layer according to the dynamic model based on the conditions where the above virtual nodes are arranged.

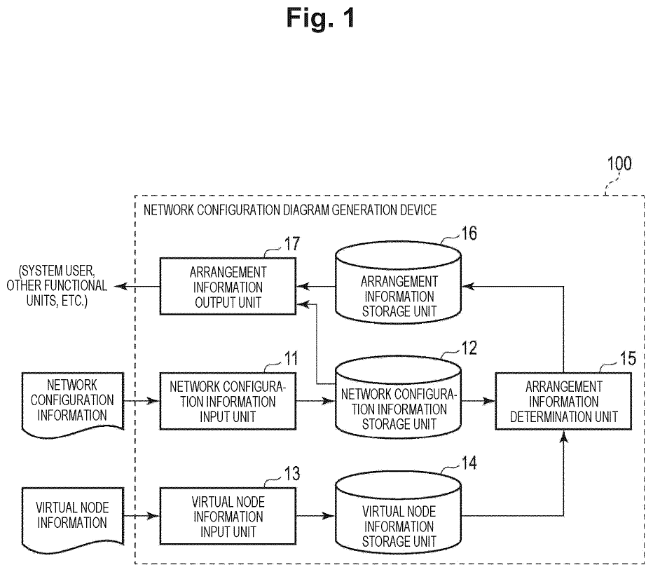

FIG. 1 is a block diagram illustrating an application example of the network configuration diagram generation device according to the embodiment of the present invention.

As illustrated in FIG. 1, a network configuration diagram generation device 100 according to the embodiment of the present invention includes: a network configuration information input unit 11; a network configuration information storage unit 12; a virtual node information input unit 13; a virtual node information storage unit 14; an arrangement information determination unit 15; an arrangement information storage unit 16; and an arrangement information output unit 17.

The network configuration information input unit 11 receives network configuration information from the outside. The network configuration information includes information on a node, information on an edge, and information indicating a feature (or an attribute) of the node.

The information input to the network configuration information input unit 11 is stored in the network configuration information storage unit 12. Hereinafter, the node indicated by the information stored in the network configuration information storage unit 12 may be referred to as a normal node.

The virtual node information input unit 13 inputs virtual node information from the outside. The virtual node information includes (1) information indicating a position and a shape of each virtual node which is a virtual node, (2) information indicating a feature of a node to which each virtual node applies an attractive force or a repulsive force, and (3) information indicating a type of force and a strength of the force generated from each virtual node. The type of force generated from each virtual node is an attractive force or a repulsive force generated from the virtual node.

The information input to the virtual node information input unit 13 is stored in the virtual node information storage unit 14.

Other units of the network configuration diagram generation device 100 will be described later.

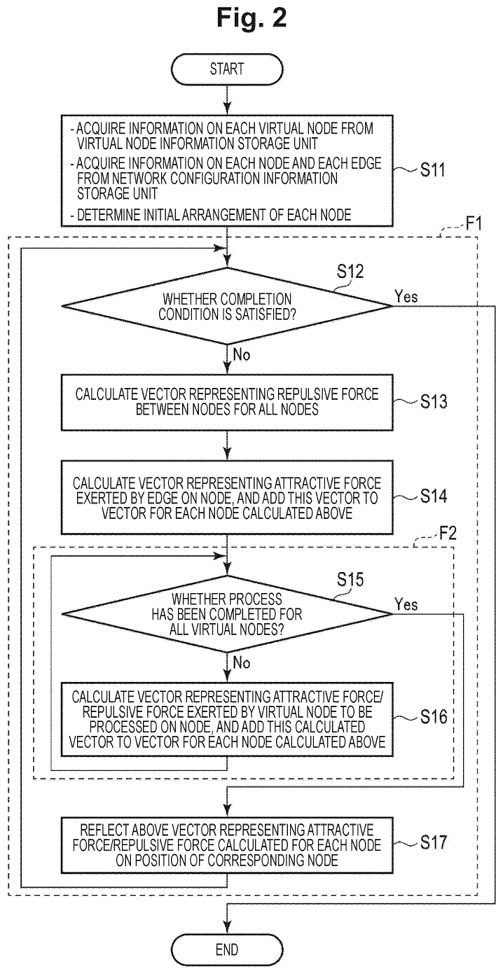

FIG. 2 is a flowchart illustrating an example of a processing operation by the network configuration diagram generation device according to the embodiment of the present invention.

The arrangement information determination unit 15 acquires information on each virtual node stored in the virtual node information storage unit 14. The arrangement information determination unit 15 acquires information on each node and each edge stored in the network configuration information storage unit 12. The arrangement information determination unit 15 determines an initial arrangement of each node including the virtual node (S11).

The arrangement information determination unit 15 calculates a vector representing a repulsive force between nodes for all the nodes indicated by the information stored in the network configuration information storage unit 12 (S13) unless the result of the process of S17 satisfies a completion condition when the subsequent processes of S13 to S17 are performed (No in S12).

As the completion condition, for example, various conditions are conceivable, such as judging each time whether or not the processes of S13 to S17 are iterated a sufficient number of times to stabilize the arrangement of the nodes or whether or not the arrangement of the nodes is stable. The number of times is predefined.

Next, the arrangement information determination unit 15 calculates a vector representing an attractive force exerted by the edge indicated by the information stored in the network configuration information storage unit 12 on the node indicated by this information, and adds this vector to the vector for each node calculated in S13 (S14).

The arrangement information determination unit 15 selects one of the virtual nodes not yet processed as a virtual node to be processed unless it has completed the subsequent process of S16 for all the virtual nodes indicated by the information stored in the virtual node information storage unit 14 (No in S15).

Then, the arrangement information determination unit 15 calculates a vector representing an attractive force or a repulsive force exerted by this virtual node to be processed on the node indicated by the information stored in the network configuration information storage unit 12. The arrangement information determination unit 15 adds the calculated vector to the vector calculated in the steps up to S14 for each node indicated by the information stored in the network configuration information storage unit 12 (S16).

The arrangement information determination unit 15 reflects the vector representing the attractive force or the repulsive force calculated for each node in the steps up to S16 on the position of the corresponding node to determine a new position of this node (S17) if it has completed the above process of S16 for all the virtual nodes indicated by the information stored in the virtual node information storage unit 14 (Yes in S15).

After S17 ends, if the result of the process of S17 satisfies the completion condition (Yes in S12), the arrangement information determination unit 15 stores the arrangement information, which is the position information indicating the position of each node determined in S17, in the arrangement information storage unit 16.

On the basis of the network configuration information stored in the network configuration information storage unit 12 and the position information stored in the arrangement information storage unit 16, the arrangement information output unit 17 displays, on a display device (not illustrated), each node arranged at the new position on the screen and information indicating the edge connecting the nodes to present the information to a maintenance person or outputs the information to another functional unit. In this manner, a series of processes ends.

For the processes of S12 to S14 and S17 surrounded by a line F1 illustrated in FIG. 2, for example, the known technique described in Non Patent Literature 1 can be employed.

However, S15 and S16 surrounded by a line F2 illustrated in FIG. 2 are processes added in this embodiment. For the calculation of the vectors in S13, S14, and S16, for example, the known technique described in Non Patent Literature 1 can be employed.

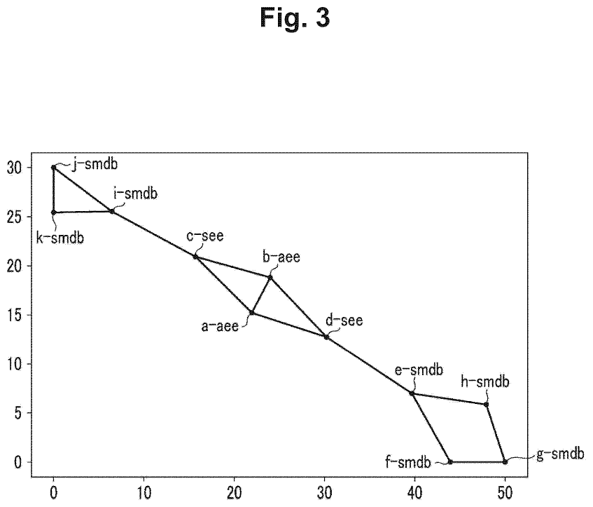

FIG. 3 is a diagram illustrating an example of a nodes arrangement result according to a general dynamic model.

In the example illustrated in FIG. 3, nodes b-aee, c-see, and d-see are directly connected to a node (here, a normal node) a-aee. The node c-see is connected to the node d-see via the node b-aee.

A node e-smdb is connected to the node d-see. A ring-shaped node that returns from the node e-smdb to the node e-smdb via nodes f-smdb, g-smdb, and h-smdb is connected to the node e-smdb.

A node i-smdb is connected to the node c-see. A ring-shaped node that returns from the node i-smdb to the node i-smdb via nodes j-smdb and k-smdb is connected to the node i-smdb.

The arrangement result illustrated in FIG. 3 corresponds to a nodes arrangement result according to the general dynamic model, which is an arrangement result in which no virtual node is set for a normal node.

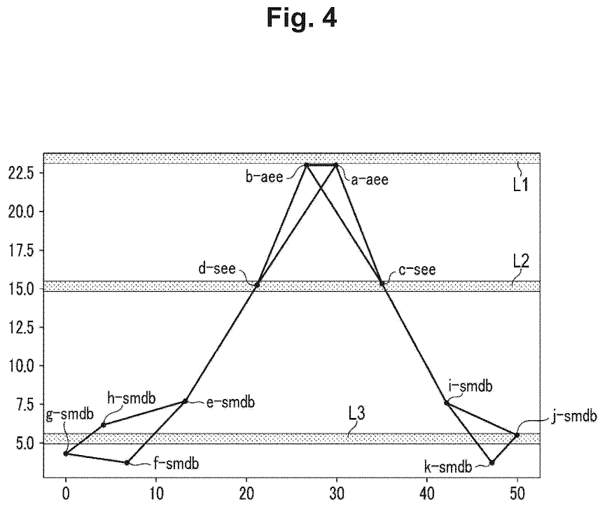

FIG. 4 is a diagram illustrating an example of a nodes arrangement result by the network configuration diagram generation device according to the embodiment of the present invention.

In the example illustrated in FIG. 4, normal nodes a-aee, b-aee, and d-see are connected to a normal node c-see in this order, the normal node c-see is further connected to the normal node b-aee, and the normal node d-see is further connected to the normal node a-aee.

A normal node e-smdb is connected to the normal node d-see, and a first ring-shaped node that returns from the normal node e-smdb to the normal node e-smdb via normal nodes f-smdb, g-smdb, and h-smdb is connected to the normal node e-smdb.

A normal node i-smdb is connected to the normal node c-see, and a second ring-shaped node that returns from the normal node i-smdb to the normal node i-smdb via normal nodes j-smdb and k-see is connected to the normal node i-smdb.

The arrangement result illustrated in FIG. 4 corresponds to an arrangement result in a case where a virtual node is set for a normal node for an object having the same structure as the network of which the arrangement is exemplified in FIG. 3.

In the example illustrated in FIG. 4, a linear virtual node L1 that applies the attractive force only to the upper layer of the network controls the positions of the normal nodes a-aee and b-aee in such a way that the normal nodes a-aee and b-aee are pulled to the arrangement position of the virtual node L1.

In addition, in the example illustrated in FIG. 4, a linear virtual node L2 that applies the attractive force only to the middle layer of the network controls the positions of the normal nodes c-see and d-see in such a way that the normal nodes c-see and d-see are pulled to the arrangement position of the virtual node L2.

Further, in the example illustrated in FIG. 4, a linear virtual node L3 that applies the attractive force only to the lower layer of the network controls the positions of the first ring-shaped node constituted of the normal nodes e-smdb, f-smdb, g-smdb, and h-smdb and the second ring-shaped node constituted of the normal nodes i-smdb, j-smdb, and k-see in such a way that the first and second ring-shaped nodes are pulled to the arrangement position of the virtual node L3.

The arrangement result according to the general dynamic model as illustrated in FIG. 3 is an arrangement result that is easy to view to some extent, but is not an arrangement result taking into consideration of the network hierarchy.

On the other hand, by the processing according to this embodiment, an arrangement result of the normal nodes taking into consideration of the network hierarchy as illustrated in FIG. 4 is obtained. Since the nodes are arranged at each of the plurality of virtual nodes so as to be consistent with the hierarchical relationship between the layers, this implements the arrangement taking into consideration of various features of the nodes in addition to implementing the viewability as in the arrangement result according to the general dynamic model. In addition, the processing according to this embodiment greatly reduces time-consuming work of manually adjusting the arrangement, leading to a reduction in operation.

Next, an example of a procedure in which a device group constituting a ring is arranged in a ring shape on a display screen will be described.

In a hierarchical network having a redundant configuration by the ring, for example, when the coordinates of nodes are fixedly determined for each layer by the node arrangement technique of the hierarchical network which is the above-described known second technique, an arrangement result taking into consideration of the hierarchy can be obtained, but this causes the devices of the same layer to be arranged in a line on the display screen.

In a case where a group of devices of the same layer constitutes a ring, if the devices of the same layer are arranged in a line as described above, this brings about an arrangement result such that the ring is crushed on the display screen. Such an arrangement result may be easy to view when the layers are checked from a macro viewpoint, but is an arrangement result that is difficult to view when a maintenance person wants to see the configuration of the hierarchical network by the ring from a micro viewpoint.

Meanwhile, in the hierarchical network having a redundant configuration by the ring, when nodes are arranged using the repulsive force between the nodes and the attractive force of an edge which are the above-described known first technique, the ring is arranged with a portion thereof having a certain extent of spread by the action of the repulsive force and the attractive force. This arrangement result is an arrangement result that is easy to view from a micro viewpoint.

In order to balance the advantages of the first and second known techniques described above, in this embodiment, the repulsive and attractive forces are introduced in the determination of the coordinates of the nodes for each of the layers described above.

More specifically, in the known second technique, the coordinates of the nodes are fixedly arranged for each layer; instead, in this embodiment, the coordinates of the nodes are arranged for each layer according to, for example, an attractive force from another node, so that the repulsive force between the nodes and the attractive force of the edge, which are used in the known first technique, and the attractive force that attracts the device group for each layer, which is simulated by the known second technique, are collectively reflected. Thus, it is possible to achieve both the advantages of the known first and second techniques described above. Accordingly, in the hierarchical network having a redundant configuration by the ring, it is possible to realize an arrangement in which the ring is no longer crushed while reflecting the hierarchy.

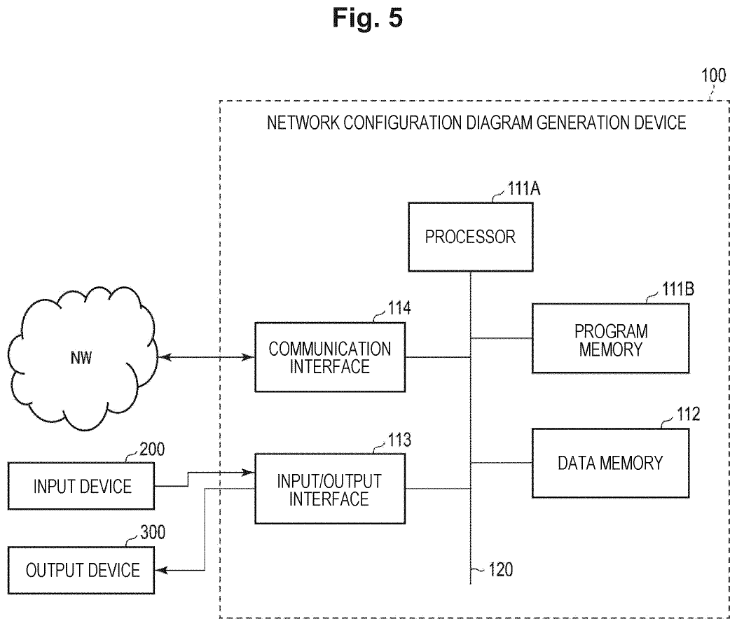

FIG. 5 is a block diagram illustrating an example of a hardware configuration of the network configuration diagram generation device according to the embodiment of the present invention.

In the example illustrated in FIG. 5, the network configuration diagram generation device 100 according to the above embodiment is constituted by, for example, a server computer or a personal computer, and includes a hardware processor 111A such as a central processing unit (CPU). Then, a program memory 111B, a data memory 112, an input/output interface 113, and a communication interface 114 are connected to the hardware processor 111A via a bus 120.

The communication interface 114 includes, for example, one or more wireless communication interface units, and enables transmission and reception of information to and from a communication network NW. As the wireless interface, for example, an interface employing a low-power wireless data communication standard such as a wireless local area network (LAN) is used.

An input device 200 and an output device 300 for a maintenance person, which are attached to the network configuration diagram generation device 100, are connected to the input/output interface 113.

The input/output interface 113 performs processes of fetching operation data input by a user through the input device 200 such as a keyboard, a touch panel, a touchpad, or a mouse, and outputting output data to the output device 300 including a display device using liquid crystal, organic electro-luminescence (EL), or the like to display the output data. Note that, as the input device 200 and the output device 300, a device built in the network configuration diagram generation device 100 may be used, or an input device and an output device of another information terminal that can communicate with the network configuration diagram generation device 100 via the network NW may be used.

The program memory 111B is used as a non-transitory tangible storage medium, for example, in a combination of a non-volatile memory enabling writing and reading at any time, such as a hard disk drive (HDD) or a solid state drive (SSD), and a non-volatile memory such as a read only memory (ROM), and stores programs necessary for executing various types of control processing according to the embodiment.

The data memory 112 is used as a tangible storage medium, for example, in a combination of the non-volatile memory described above and a volatile memory such as a random access memory (RAM), and is used to store various types of data acquired and created in the process of performing various types of processing.

The network configuration diagram generation device 100 according to the embodiment of the present invention can be configured as a data processing device including the network configuration information input unit 11, the virtual node information input unit 13, the arrangement information determination unit 15, and the arrangement information output unit 17 illustrated in FIG. 1 as a processing function unit by software.

The network configuration information storage unit 12, the virtual node information storage unit 14, and the arrangement information storage unit 16 can be configured by using the data memory 112 illustrated in FIG. 5. However, these areas are not essential configurations in the network configuration diagram generation device 100, and may be areas provided in, for example, an external storage medium such as a universal serial bus (USB) memory or a storage device such as a database server arranged in a cloud.

All of the processing function units in each of the network configuration information input unit 11, the virtual node information input unit 13, the arrangement information determination unit 15, and the arrangement information output unit 17 described above can be realized by causing the hardware processor 111A described above to read and execute the program stored in the program memory 111B. Note that some or all of these processing function units may be implemented in other various forms including an integrated circuit such as an application specific integrated circuit (ASIC) or a field-programmable gate array (FPGA).

As described above, the network configuration diagram generation device according to the embodiment of the present invention inputs information on a plurality of nodes displayable on a screen and at least one edge connecting two of the plurality of nodes, sets a virtual node which generates an attractive force or a repulsive force for a node having a predetermined feature out of the plurality of nodes, calculates the attractive force or the repulsive force related to the plurality of nodes and the set virtual node, and controls the display positions of the plurality of nodes on the screen on the basis of the calculated attractive force or repulsive force. Thus, the nodes can be appropriately arranged in consideration of the features of the nodes.

Next, other applications according to this embodiment will be described.

For example, by employing this embodiment to reflect the longitude of a building, in which a device corresponding to a node is accommodated (arranged), on the arrangement of the node on the screen, the attractive source of a vertical line for each building's longitude can be arranged on the screen as a virtual node so that the node is pulled on the screen toward the longitude of the building in which the device is accommodated. This virtual node acts only on a node accommodated in a building corresponding to a predetermined longitude. As a result, it is possible to obtain a result in which each node is appropriately arranged according to the longitude of a building in which this node is accommodated.

Meanwhile, for example, by employing this embodiment when generating a screen in which nodes subjected to clustering are gathered at a place specified for each cluster, it is possible to arrange dotted virtual nodes, which apply an attractive force only to nodes belonging to each cluster, on the screen at positions corresponding to each of the clustered nodes.

In the above-described embodiment, the example employed in the display of the network configuration has been described. However, the present invention is not limited thereto, and for example, the present invention can also be employed in the arrangement of plots of a general graph on a screen.

In addition, the method described in each embodiment can be stored in a recording medium such as a magnetic disk (Floppy (registered trademark) disk, hard disk, and the like), an optical disc (CD-ROM, DVD, MO, and the like), or a semiconductor memory (ROM, RAM, flash memory, and the like) as a program (software means) that can be executed by a computer, and can be distributed by being transmitted through a communication medium. Note that the program stored in the medium side also includes a setting program for configuring, in the computer, software means (including not only an execution program but also tables and data structures) to be executed by the computer. The computer that realizes the present device executes the above-described processing by reading the program recorded in the recording medium, constructing the software means by the setting program as needed, and controlling the operation by the software means. Note that the recording medium described in the present specification is not limited to a recording medium for distribution, but includes a storage medium such as a magnetic disk or a semiconductor memory provided in the computer or in a device connected via a network.

Note that the present invention is not limited to the foregoing embodiment and various modifications can be made in the implementation stage without departing from the gist of the invention. In addition, each embodiment may be implemented in appropriate combination, and in that case, combined effects can be obtained. Furthermore, the embodiment described above includes various inventions, and various inventions can be extracted by a combination selected from a plurality of disclosed components. For example, even if some components are deleted from all the components described in the embodiment, in a case where the problem can be solved and the effects can be obtained, a configuration from which the components are deleted can be extracted as an invention.

### REFERENCE SIGNS LIST

100 Network configuration diagram generation device
11 Network configuration information input unit
12 Network configuration information storage unit
13 Virtual node information input unit
14 Virtual node information storage unit
Arrangement information determination unit
16 Arrangement information storage unit
17 Arrangement information output unit

1. A position control device comprising:
setting circuitry that inputs information on a plurality of nodes displayable on a screen and at least one edge connecting two of the plurality of nodes, and sets a virtual node which generates an attractive force or a repulsive force for a node having a predetermined feature out of the plurality of nodes indicated by the information thus input;
calculation circuitry that calculates an attractive force or a repulsive force related to the plurality of nodes and the virtual node set by the setting circuitry; and
control circuitry that controls display positions of the plurality of nodes on the screen on the basis of the attractive force or the repulsive force calculated by the calculation circuitry.

2. The position control device according to claim 1, wherein:
the calculation circuitry calculates a first vector representing a repulsive force generated between the plurality of nodes, a second vector representing an attractive force exerted on the nodes by the edge, and a third vector representing an attractive force or a repulsive force exerted on the plurality of nodes by the virtual node set by the setting circuitry, and calculates a vector obtained by adding the first, second, and third vectors, and
the control circuitry controls the display positions of the plurality of nodes on the screen on the basis of the added vector calculated by the calculation circuitry.

3. The position control device according to claim 1, wherein:
the plurality of nodes form a network configuration, and
the setting circuitry sets, for the plurality of layers, the virtual node which generates an attractive force or a repulsive force for a node belonging to a predetermined layer in the network configuration out of the plurality of nodes indicated by the information thus input.

4. The position control device according to claim 1, wherein:
the virtual node is a dotted or linear node on the screen.

5. A position control method, comprising:
inputting information on a plurality of nodes displayable on a screen and at least one edge connecting two of the plurality of nodes, and setting a virtual node which generates an attractive force or a repulsive force for a node having a predetermined feature out of the plurality of nodes indicated by the information thus input;
calculating an attractive force or a repulsive force related to the plurality of nodes and the virtual node thus set; and
controlling display positions of the plurality of nodes on the screen on the basis of the attractive force or the repulsive force which has been calculated.

6. The position control method according to claim 5, wherein:
the calculating includes calculating a first vector representing a repulsive force generated between the plurality of nodes, a second vector representing an attractive force exerted on the nodes by the edge, and a third vector representing an attractive force or a repulsive force exerted on the plurality of nodes by the virtual node set by the setting circuitry, and calculating a vector obtained by adding the first, second, and third vectors.

7. The position control method according to claim 5, wherein:
the plurality of nodes form a network configuration, and
the setting includes setting, for the plurality of layers, the virtual node which generates an attractive force or a repulsive force for a node belonging to a predetermined layer in the network configuration out of the plurality of nodes indicated by the information thus input.

8. A non-transitory computer readable medium storing a position control program for causing a processor to function as each of the circuitries of the position control device according to claim 1.

9. A non-transitory computer readable medium storing a program for causing a processor to perform the method of claim 5.
